(19) United States
(12) Patent Application Publication
(10) Pub. No.: US 2007/0107831 A1
(43) Pub. Date: May 17, 2007

(54) Method of bonding cable harnesses adhesively to substrates such as the interior decorative components of a passenger car, especially roof lining, door side part and boot lid

(76) Inventors: Matthias Von Samson-Himmelstjerna, Henstedt-Ulzburg (DE); Michael Schwertfeger, Hamburg (DE)

Correspondence Address: NORRIS, MCLAUGHLIN & MARCUS, PA, 875 THIRD AVENUE, 18TH FLOOR, NEW YORK, NY, 10022, US

(21) Appl. No.: 10/575,646

(22) PCT Filed: Sep. 30, 2004
(86) PCT No.: PCT/EP04/52371

§ 371 Date: Nov. 13, 2006

(30) Foreign Application Priority Data
Oct. 17, 2003 (DE) 103 49 107.4

(51) Int. Cl. B32B 37/00

(52) U.S. Cl. 156/191; 156/290

(57) ABSTRACT

A method for gluing cable trees to base structures of a passenger car, particularly roof liners, lateral door parts, luggage compartment lids, wherein individual cables are encompassed by a textile strip which is preferably provided with a self-adhesive coating on one side thereof, such that a cable harness is created, and the cable harness is fixed on the base structure by means of one or more double-sided adhesive tape sections.

This application is a 371 of PCT/EP2004/052371, filed Sep. 30, 2004, which claims foreign priority benefit under 35 U.S.C. § 119 of the German Patent Application No. 103 49 107.4 filed Oct. 17, 2003.

The invention relates to a method of bonding cable harnesses adhesively to substrates such as the interior decorative components of a passenger car, especially roof lining, door side part and boot lid.

Parts which are to be fixed by means of a double-sided adhesive tape (for example flat ribbon cable, displays, cardboard packaging) are very often made self-adhesive beforehand completely with the tape. This entails a very high level of material consumption, and not only the even edging of parts with an adhesive tape but also the necessary removal of the adhesive tape liner later on, during assembly, are very time-consuming operations.

One alternative is to apply individual adhesive dots directly at the assembly stage, and then to bond the part to these dots subsequently. This operation, again, is inconvenient, since the adhesive dots are also provided with a liner which has to be removed beforehand.

Certain parts (for example electronic components or seals in mobile telephones) compel the use of double-sidedly adhesive diecuts, depending on application. These diecuts are individual sections of adhesive tape which either are arranged immediately following one another on a backing web or are located on the backing web at a given distance from one another, this distance being regular or irregular.

These diecuts must be converted to the required shape beforehand in a diecutting operation, particularly by what is known as the kiss-cut operation, in which case the tape which is made adhesive in order to produce the diecuts must be lined with an antiadhesive material beforehand.

The feature of the kiss-cut process is that, in the course of diecutting, the antiadhesive material is not, or not substantially, injured or cut into. This prevents adhesive from the diecuts running into the incisions after the diecutting operation and sticking to the material. Were this to occur, the material could split in downstream production steps involving the further processing of the material with the diecuts. In that case the entire roll would be excluded from further processing and would therefore become waste.

Further applications of such double-sidedly adhesive diecuts are to be found in the automotive sector. One example which may be highlighted is the adhesive bonding of flat cables in the roof lining of passenger cars.

Cables for motor vehicles are very often nowadays bundled into looms by wrapping with an adhesive tape. The cable strands are fastened within the vehicle mechanically by means of cable clips, by over-bonding with an adhesive tape, or by means of pastelike adhesive systems (hotmelt adhesives, for example).

All these types of fixing are very time consuming and have the disadvantage, moreover, that they are not in accordance with the desire on the part of many automotive component manufacturers for greater automation. Furthermore, manual work is required, with the risks of fluctuating quality levels.

It is an object of the invention to provide a method which, with a very simple construction, applies cable harnesses very efficiently and precisely, with high positional precision, to, for example, a passenger car component, and does so using double-sided adhesive tape sections and/or diecuts.

This object is achieved by means of a method as described herein. The method of bonding cable harnesses adhesively to substrates such as the interior decorative components of a passenger car (automobile), especially roof lining, door side part or boot (trunk) lid, is composed of the following steps:
individual cables are enveloped with a textile tape provided preferably on one side with a self-adhesive coating, thus forming a cable harness,
the cable harness is fixed to the substrate by means of double-sided adhesive tape sections.

The cables are preferably wrapped with a single-sided adhesive tape, with an adhesive being applied partially, in stripes or over the full area of the textile tape. The resultant adhesive tape is with further preference guided around the cables in such a way that the adhesive is on the inside relative to the center axis of the cables.

The textile tape ought preferably to be readily adhering and fibrous, but ought also to exhibit sufficient internal strength. The tape ought to allow the individual cables to be bundled without shrinkback, thus producing a loose sheathing of the cables.

As the textile tape it is possible to use all known textile backings such as wovens, knits or nonwoven webs; the term “web” embraces at least textile sheetlike structures in accordance with EN 29092 (1988) and also stitchbonded nonwovens and similar systems.

It is likewise possible to use spacer fabrics, including wovens and knits, with lamination. Spacer fabrics of this kind are disclosed in EP 0 071 212 B1. Spacer fabrics are matlike layer structures comprising a cover layer of a fiber or filament fleece, an underlayer and individual retaining fibers or bundles of such fibers between these layers, said fibers being distributed over the area of the layer structure, being needled through the particle layer, and joining the cover layer and the underlayer to one another. As an additional though not mandatory feature, the retaining fibers in accordance with EP 0 071 212 B1 comprise inert mineral particles, such as sand, gravel or the like, for example. The holding fibers needled through the particle layer hold the cover layer and the underlayer at a distance from one another and are joined to the cover layer and the underlayer. Spacer wovens or spacer knits are described, inter alia, in two articles, namely
an article from the journal kettenwirk-praxis 3/93, 1993, pages 59 to 63, “Raschelgewirkte Abstandsgewirke” [Raschel-knitted spacer knits] and
an article from the journal kettenwirk-praxis 1/94, 1994, pages 73 to 76, “Raschelgewirkte Abstandsgewirke”,
   the content of said articles being included here by reference and being part of this disclosure and invention.

Suitable nonwovens include, in particular, consolidated staple fiber webs, but also filament webs, meltblown webs, and spunbonded webs, which generally require additional consolidation. Known consolidation methods for webs are mechanical, thermal, and chemical consolidation. Whereas with mechanical consolidations the fibers can be held together purely mechanically by entanglement of the individual fibers, by the interlooping of fiber bundles or by the stitching-in of additional threads, it is possible by thermal and by chemical techniques to obtain adhesive (with binder) or cohesive (binderless) fiber-fiber bonds. Given appropriate formulation and an appropriate process regime, these bonds may be restricted exclusively, or at least predominantly, to the fiber nodal points, so that a stable, three-dimensional network is formed while retaining the loose open structure in the web.

Webs which have proven particularly advantageous are those consolidated in particular by overstitching with separate threads or by interlooping.

Consolidated webs of this kind are produced, for example, on stitchbonding machines of the “Malifleece” type from the company Karl Mayer, formerly Malimo, and can be obtained from, inter alia, the companies Naue Fasertechnik and Techtex GmbH. A Malifleece is characterized in that a cross-laid web is consolidated by the formation of loops from fibers of the web. The tape used may also be a web of the Kunit or Multiknit type. A Kunit web is characterized in that it originates from the processing of a longitudinally oriented fiber web to form a sheetlike structure which has the heads and legs of loops on one side and, on the other, loop feet or pile fiber folds, but possesses neither threads nor prefabricated sheetlike structures. A web of this kind has been produced, inter alia, for many years, for example on stitchbonding machines of the “Kunitviies” type from the company Karl Mayer. A further characterizing feature of this web is that, as a longitudinal-fiber web, it is able to absorb high tensile forces in the longitudinal direction. The characteristic feature of a Multiknit web relative to the Kunit is that the web is consolidated on both the top and bottom sides by virtue of the double-sided needle punching. Finally, stitchbonded webs as an intermediate are also suitable for forming an adhesive tape of the invention. A stitchbonded web is formed from a nonwoven material having a large number of stitches extending parallel to one another. These stitches are brought about by the incorporation, by stitching or knitting, of continuous textile threads. For this type of web, stitchbonding machines of the “Maliwatt” type from the company Karl Mayer, formerly Malimo, are known.

Also particularly advantageous is a staple fiber web which is mechanically preconsolidated in the first step or is a wet-laid web laid hydrodynamically, in which between 2% and 50% of the web fibers are fusible fibers, in particular between 5% and 40% of the fibers of the web. A web of this kind is characterized in that the fibers are laid wet or, for example, a staple fiber web is preconsolidated by the formation of loops from fibers of the web or by needling, stitching or air-jet and/or water-jet treatment. In a second step, thermofixing takes place, with the strength of the web being increased again by the (partial) melting of the fusible fibers. The web backing may also be consolidated without binders, by means for example of hot embossing with structured rollers, with properties such as strength, thickness, density, flexibility, and the like being controllable via the pressure, temperature, residence time, and embossing geometry.

For the inventive use of nonwovens, the adhesive consolidation of mechanically preconsolidated or wet-laid webs is of particular interest, it being possible for said consolidation to take place by way of the addition of binder in solid, liquid, foamed or pastelike form. A great diversity of theoretical embodiments is possible: for example, solid binders as powders for trickling in; as a sheet or as a mesh, or in the form of binding fibers. Liquid binders may be applied as solutions in water or organic solvent or as a dispersion. For adhesive consolidation, binder dispersions are predominantly chosen: thermosets in the form of phenolic or melamine resin dispersions, elastomers as dispersions of natural or synthetic rubbers, or, usually, dispersions of thermoplastics such as acrylates, vinyl acetates, polyurethanes, styrene-butadiene systems, PVC, and the like, and also copolymers thereof. Normally, the dispersions are anionically or nonionically stabilized, although in certain cases cationic dispersions may also be of advantage.

The binder may be applied in a manner which is in accordance with the prior art and for which it is possible to consult, for example, standard works of coating or of nonwoven technology such as “Vliesstoffe” (Georg Thieme Verlag, Stuttgart, 1982) or “Textiltechnik-Vliesstofferzeugung” (Arbeitgeberkreis Gesamttextil, Eschborn, 1996).

For mechanically preconsolidated webs which already possess sufficient composite strength, the single-sided spray application of a binder is appropriate for effecting specific changes in the surface properties. Such a procedure is not only sparing in its use of binder but also greatly reduces the energy requirement for drying. Since no squeeze rollers are required and the dispersion remains predominantly in the upper region of the web material, unwanted hardening and stiffening of the web can very largely be avoided. For sufficient adhesive consolidation of the web backing, the addition of binder in the order of magnitude of 1% to 50%, in particular 3% to 20%, based on the weight of fiber web, is generally required.

The binder may be added as early as during the manufacture of the web, in the course of mechanical preconsolidation, or else in a separate process step, which may be carried out in-line or off-line. Following the addition of the binder it is necessary temporarily to generate a condition in which the binder becomes adhesive and adhesively connects the fibers—this may be achieved during the drying, for example, of dispersions, or else by heating, with further possibilities for variation existing by way of area or partial application of pressure. The binder may be activated in known drying tunnels, or else, given an appropriate selection of binder, by means of infrared radiation, UV radiation, ultrasound, high-frequency radiation or the like. For the subsequent end use it is sensible, although not absolutely necessary, for the binder to have lost its tack following the end of the web production process. It is advantageous that, as a result of the thermal treatment, volatile components such as fiber assistants are removed, giving a web having favorable fogging values, so that when a low-fogging adhesive is used it is possible to produce an adhesive tape having particularly advantageous fogging values.

A further, special form of adhesive consolidation consists in activating the binder by incipient dissolution or swelling. In this case it is also possible in principle for the fibers themselves, or admixed special fibers, to take over the function of the binder. Since, however, such solvents are objectionable on environmental grounds, and/or are problematic in their handling, for the majority of polymeric fibers, this process is not often employed.

Starting materials envisaged for the textile backing include, in particular, polyester, polypropylene, viscose or cotton fibers. The present invention is, however, not restricted to said materials; rather it is possible to use a large number of other fibers to produce the web, this being evident to the skilled worker without any need for inventive activity.

Low flammability in the tape and/or in the adhesive tapes may be achieved by adding flame retardants to the (web) backing and/or to the adhesive. These retardants may be organobromine compounds, together where appropriate with synergists such as antimony trioxide; however, with a view to the absence of halogens from the adhesive tape, preference will be given to using red phosphorus, organophosphorus compounds, mineral compounds or intumescent compounds such as ammonium polyphosphate, alone or in conjunction with synergists.

In one advantageous embodiment the adhesive bonding of the double-sided adhesive tape sections to the cable harness and/or substrate takes place by means of an apparatus for unrolling a backing material web, present on a roll, with the double-sided adhesive tape sections, the said apparatus comprising
a handle fitted to a baseplate,
a receiver mounted rotatably on the baseplate and intended for the roll of backing material web,
a pressure roller which is mounted rotatably on the baseplate and which during the dispensing operation brings the backing material web with the adhesive tape sections into contact with the substrate, and via which the backing material web with the adhesive tape sections is guided from the receiver for the roll in such a way that the adhesive tape sections are dispensed onto the substrate from the backing material web during the dispensing operation,
a drive roller which is mounted rotatably on the baseplate and via which the backing material web with the adhesive tape sections is guided in such a way that the drive roller rotates synchronously with respect to the speed of the backing material web,
a receiving roller which is mounted rotatably on the baseplate and which receives the backing material web after the adhesive tape sections have been dispensed, and which in particular is set in rotation via a belt by the movement of the drive roller.

In another preferred embodiment the drive roller is disposed between the receiver for the roll of backing material web and the pressure roller.

In another preferred embodiment a guide roller is disposed between the receiver for the roll of backing material web and the drive roller, in order to produce a very high angle of wrap of the backing material web around the drive roller. In this way, secure transmission of the movement of the backing material web to the drive roller and therefore, via the preferred belt, to the receiving roller is ensured.

With further preference, on an axle which can be fixed on the handle there is an adjustable positioning aid, in particular in the form of a rotatable shaft which can be fixed by screwing, via which the backing material web is guided from the receiver for the roll of backing material web in the direction of the drive roller.

This positioning aid, composed in particular of a shaft which is to be guided movably in a groove, and which can be fixed at any desired position within the groove by screwing, serves to ensure, depending on the application of the adhesive tape sections, that the beginning and/or end of the adhesive tape sections, especially double-sided adhesive tape sections, is always at a predetermined position, so that the adhesive bond always begins in a defined manner at the beginning of an adhesive tape section with a length, for example, of 15 mm, and that after the dispensing operation, in other words when, for example, the apparatus has been drawn once over a section of the cable harness, the adhesive bond ends at the end of another adhesive tape section with a length, for example, of 15 mm.

Another possible exemplary solution for a positioning aid of this kind is an additional, small magnifying lens with marking, which can be positioned in the same way.

The distance between pressure roller and positioning aid is individually adjustable, in adaptation of the length of the double-sided adhesive tape sections. By means of this positioning aid the user of the apparatus is always able to stay within the relationship determined by the length of the adhesive tape sections.

In order to make the apparatus easy to use for both left-handers and right-handers, the handle and all other components can be mounted in mirror-image form on the baseplate.

A further preferred version in the receiver for the roll of backing material web is an adjustable brake, in particular a friction brake. This brake ensures a uniform tension, not too low, in the backing material web during the dispensing operation.

In another preferred embodiment one side of the pressure roller is fixed on the baseplate and the other side carries a counterplate. In the case of the apparatus which is pushed during the dispensing operation, the counterplate and the baseplate are of prolonged design in the direction of the handle. The counterplate and the baseplate are harmonized in their shape with the pressure roller and with the lever arm of the handle, so that at the end of the dispensing operation the apparatus as a whole can easily be swiveled by the user about the fulcrum which arises from this geometry. As a result of this rotational movement, in conjunction with the positioning aid, on the one hand it is always possible to dispense the last adhesive tape section reliably, i.e., to transfer it from the backing material web to the substrate, while on the other hand the next adhesive tape section, not to be bonded until later, is still held securely on the backing material web.

Suitable materials for the components include plastics, although a metal version is also possible.

The apparatus for unrolling can in a further embodiment be moved not by a manual movement but by a standard automatic handling device. In this case it is preferred for a mechanical/electrical positioning aid, in addition to a customary optical/electric positioning aid, to be employed as follows: The rotatable shaft which is adjustable in the groove possesses an additional shaft connected mechanically to it, in the form for example of a toothed wheel, which penetrates a free edge region of the backing material web that is not masked by the adhesive tape sections. As a result, the relationship once set manually, in other words the precise distance between positioning aid and pressure roller, can no longer be departed. A standard rotation sensor, fixed mechanically to the shaft of the toothed wheel, is then used to drive the automatic handling device, in other words to initiate beginning and end of the movement needed for the dispensing operation.

With preference, accordingly, the apparatus is guided by a robot, so that adhesive tape sections are applied to the cable harness at precisely predetermined locations.

The apparatus is suitable for applying a multiplicity of backing materials which are present on a roll and on which self-adhesive tape sections and/or diecuts are present.

These diecuts are produced in a converting operation in which a double-sidedly adhesive tape is placed on the backing material and diecuts are punched out of said tape, in particular in a kiss-cut operation.

The backing material web in question is preferably a web of backing material on which double-sidedly self-adhesive tape sections are disposed, an antiadhesive coating being applied to both sides of the backing material web, and the two antiadhesive coatings differing in their degree of their repellency toward the adhesive of the adhesive tape sections.

In one advantageous embodiment the antiadhesive coating located on the top face of the backing material web has a lower repellency than the antiadhesive coating located on the bottom face of the backing material. When the backing material web is in its unrolled state, the adhesive tape sections are on its top face. This ensures that
the individual adhesive tape sections can be converted and made available on the backing material web in the form of a roll without further auxiliary means (for example a second lining); during the converting operation (cutting-to-size of the adhesive tape sections) the superfluous material can be taken off as a matrix and discarded, and
the adhesive tape sections can be dispensed easily by means of the apparatus of the invention.

As backing material web it is preferred to use paper, a paper/polyolefin composite and/or a film. Suitable backing materials further include, in principle, films such as, for example, BOPP or MOPP, PET, PVC or nonwovens (based on cellulose or polymers). Also suitable are foams (for example PU, PE, PE/EVA, EPDM, PP, PE, silicone, etc.) or release papers (kraft papers, polyolefin-coated papers) or release films (PET, PP or PE or combinations of these materials) as coating substrates.

As the antiadhesive coating it is preferred to use a solventlessly coated silicone. With further preference the antiadhesive coating and/or solventlessly coated silicone is applied at 0.8 to 3.7 g/m², preferably 1.3 to 3.2 g/m², very preferably 1.8 to 2.8 g/m².

Solventborne systems, however, are also possible as antiadhesive coating, at an application rate in particular of 0.3 to 1 g/m².

Materials used additionally as backings for the adhesive tape sections are preferably web-form materials such as paper, nonwovens, polymeric films, and foams. All kinds of double-faced adhesive tapes are suitable in principle as base material for the adhesive tape sections. As adhesives for the adhesive tapes it is possible to use all pressure-sensitive adhesives such as are mentioned, for example, in SATAS, Handbook of Pressure Sensitive Adhesive Technology, Third Edition. Particularly suitable are natural/synthetic rubber-based and acrylate-based adhesives which can be applied from the melt or solution.

In accordance with the invention it is further possible as backing material to use highly compacted glassine papers provided with a polymeric coating on the top and/or bottom side, an antiadhesive layer, in particular a silicone coating, having been applied to at least one of the two polymeric coatings present where appropriate.

In a further embodiment of the invention a paper backing material with a density of from 1.1 to 1.25 g/cm³ is used, the paper backing essentially having a top side and a bottom side. On the top and/or bottom side the paper backing is provided with a polymeric coating, an antiadhesive layer having been applied at least to one of the two polymeric coatings present where appropriate.

The paper backing or glassine paper preferably has a density of from 1.12 to 1.2 g/cm³, in particular from 1.14 to 1.16 g/cm³. With further preference the paper backing or glassine paper has a basis weight of from 40 to 120 g/m², preferably from 50 to 110 g/m², very preferably from 60 to 100 g/m².

Polymers used for the polymeric coating include in particular polyolefins such as LDPE, HDPE, blends of these two, for example MDPE, PP or PET. LDPE is especially advantageous.

The poly-coated sides of the LDPE or HDPE paper backing can also be produced so as to be matt or glossy.

With further preference the polymeric coating is applied at 5 to 30 g/m², preferably 10 to 25 g/m², very preferably 15 to 20 g/m². In the case of polyester, in particular, application may also take place at just 2 to 3 g/m².

Furthermore, one outstanding development of the invention is the use as antiadhesive layers of, for example, silicone, paraffin, Teflon or waxes. In that case it is possible to use silicone-free release layers, for example “non Silicone” from Rexam, or low-silicone release layers, for example “Lo ex” from Rexam.

Depending on the application of the paper backing material it is possible to give the antiadhesive layers the same or different release qualities on either side of the backing material, hence including the possibility of setting different release properties on either side (controlled release).

In this way it is ensured that, in the case of poly-coating on both sides, the liner material exhibits
dimensional stability properties (good flatness)
a low thickness with high consistency of thickness (narrow tolerances, more precise diecuts)
and a layer which protects against diecutting into the body of the paper
   or that, in the case of poly-coating on one side, the liner material exhibits
a low thickness with high consistency of thickness (narrow tolerances, more precise diecuts) and
a layer which protects against diecutting into the body of the paper.

For use in the apparatus it is especially advantageous if the individual adhesive tape sections are arranged in the form of rectangles on the backing material web. It is further very advantageous if these rectangles are arranged on the backing material web without any distance between the individual adhesive tape sections. The production of such adhesive tape sections on a backing material web without any distance between them is often very difficult owing to the coalescence of the adhesive. With further preference, therefore, a backing material web can be used on which there are arranged diecuts composed of a pressure-sensitive adhesive which possesses anisotropic properties.

In the course of the production, further processing, or later stressing of polymers or polymer compositions it is possible for high degrees of orientation of the macromolecules in preferred directions in the overall polymer assembly to form; as a result of this orientation, which can also be induced deliberately, it is possible to steer the properties of the corresponding polymers and to improve them in respect of desired applications. Anisotropically oriented pressure-sensitive adhesives possess the tendency to return to the initial state following stretching in a given direction, as a result of their “entropy-elastic” behavior. Suitable for use in principle are all pressure-sensitive adhesives which exhibit an orientation, examples being those based on natural and synthetic rubbers such as butyl rubber, neoprene, butadiene-acrylonitrile, styrene-butadiene-styrene and styrene-isoprene-styrene copolymers, and also those based on linear polyesters and copolyesters, polyurethanes, polysiloxane elastomers, those based on straight acrylates, but especially polyacrylate-based anisotropic pressure-sensitive adhesives. Such anisotropically oriented acrylate pressure-sensitive adhesives, in the form of a layer after punching and/or cutting operations, exhibit a retreat of the pressure-sensitive adhesive layer at the cut and punched edge, which is utilized for the diecutting of punched shapes which do not coalesce.

One advantageous development uses a pressure-sensitive adhesive
which is obtainable by free-radical polymerization,
which is composed to the extent of at least 65% by weight of at least one acrylic monomer from the group of compounds of the following general formula: 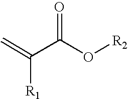
   where R₁=H or CH₃ and the radical R₂=H or CH₃ or is selected from the group of branched and unbranched, saturated alkyl groups having 2 to 20 carbon atoms, preferably 4 to 9 carbon atoms, for which the average molecular weight of the pressure-sensitive adhesive is at least 650 000, and which, when applied to a backing, possesses a preferential direction, the refractive index measured in the preferential direction, n_{MD}, being greater than the refractive index measured in a direction perpendicular to the preferential direction, n_{CD}, and where the difference Δn=n_{MD}−n_{CD} amounts to at least 1×10⁻⁵.

Non-exclusive examples of alkyl groups which may find preferred application for the radical R₂ include butyl, pentyl, hexyl, heptyl, octyl, isooctyl, 2-methylheptyl, 2-ethylhexyl, nonyl, decyl, dodecyl, lauryl, or stearyl (meth)acrylate or (meth)acrylic acid.

The diecutting procedure is also excellent when using a pressure-sensitive adhesive based to an extent of up to 35% by weight on comonomers in the form of vinyl compounds, especially one or more vinyl compounds selected from the following group: vinyl esters, vinyl halides, vinylidene halides, nitriles of ethylenically unsaturated hydrocarbons. For the purposes of this utility, acrylic compounds with functional groups are also embraced by the term “vinyl compound”. Vinyl compounds of this kind containing functional groups are maleic anhydride, styrene, styrenic compounds, vinyl acetate, (meth)acrylamides, N-substituted (meth)acrylamides, β-acryloyloxypropionic acid, vinylacetic acid, fumaric acid, crotonic acid, aconitic acid, dimethylacrylic acid, trichloroacrylic acid, itaconic acid, vinyl acetate, hydroxyalkyl (meth)acrylate, amino-containing (meth)acrylates, hydroxyl-containing (meth)acrylates, especially 2-hydroxyethyl (meth)acrylate, 2-hydroxypropyl (meth)acrylate, and/or 4-hydroxybutyl (meth)acrylate, and double-bond-functionalized photoinitiators; the above listing is only exemplary and not exhaustive.

For the pressure-sensitive adhesives it is especially advantageous if the composition of the corresponding monomers is chosen such that the resultant adhesives possess pressure-sensitive adhesion properties in accordance with D. Satas [Handbook of Pressure Sensitive Adhesive Technology, 1989, VAN NOSTRAND REINHOLD, N.Y.]. For this purpose the glass transition temperature of the acrylate pressure-sensitive adhesive should be situated, for example, below 25° C.

The pressure-sensitive adhesives employed for the utility, particularly the polyacrylate pressure-sensitive adhesives praised above for their advantage, are prepared preferably by a free-radically initiated polymerization. One process very suitable for this purpose is distinguished by the following steps:
polymerization of a mixture comprising at least one vinyl-, acryloyl- or methacryloyl-based monomer or a combination of these monomers, the average molecular weight of the resultant polymers being situated above 650 000,
subsequent extrusion coating of the polymer composition,
subsequent crosslinking of the polymer composition on the backing by irradiation with electron beams.

Extrusion coating takes place preferably through an extrusion die. The extrusion dies used may come from one of the three following categories: T-dies, fishtail dies, and coat hanger dies. The individual types differ in the design of their flow channel. For the preparation of oriented acrylate pressure-sensitive adhesives it is particularly preferred to carry out coating onto a backing using a coat hanger die, specifically such that a layer of polymer on the backing is formed by a movement of die relative to backing. The period between coating and crosslinking is advantageously very short, preferably no greater than 10 s. By virtue of the shaping of the acrylate hotmelt in the coat hanger die and its emergence from the die with a defined film thickness, as a result of the stretching of the film of pressure-sensitive adhesive as it transfers to the backing material, to give a thinner film thickness, and as a result of the subsequent inline crosslinking, the orientation is obtained.

The free radical polymerization can be conducted in the presence of an organic solvent or in the presence of water, or in mixtures of organic solvents and water, or in bulk. It is preferred to use as little solvent as possible. Depending on conversion and temperature, the polymerization time amounts to between 6 and 48 h. In the case of solution polymerization the solvents used are preferably esters of saturated carboxylic acids (such as ethyl acetate), aliphatic hydrocarbons (such as n-hexane or n-heptane), ketones (such as acetone or methyl ethyl ketone), special-boiling-point spirit, or mixtures of these solvents. For polymerization in aqueous media or in mixtures of organic and aqueous solvents, the emulsifiers and stabilizers known to the person skilled in the art for this purpose are added to the polymerization. Polymerization initiators used are customary radical-forming compounds such as peroxides, azo compounds and peroxosulfates, for example. Initiator mixtures, too, can be used. During the polymerization it is possible to use further regulators to lower the molecular weight and to reduce the polydispersity. As polymerization regulators it is possible, for example, to use alcohols and ethers. The molecular weight of the acrylate pressure-sensitive adhesives lies advantageously between 650 000 and 2 000 000 g/mol, more preferably between 700 000 and 1 000 000 g/mol.

In a further procedure the polymerization is carried out in polymerization reactors which are generally provided with a stirrer, two or more feed vessels, reflux condenser, heating and cooling and are equipped for operation under an N₂ atmosphere and superatmospheric pressure.

Following the polymerization in solvent the polymerization medium can be removed under reduced pressure, this operation being conducted at elevated temperatures, in the range from 80 to 150° C., for example. The polymers can then be used in the solvent-free state, in particular as hotmelt pressure-sensitive adhesives [hotmelt PSAs]. In some cases it is also advantageous to prepare the polymers of the invention without solvent.

To prepare the acrylate PSAs the polymers can be given a conventional modification. For example, tackifying resins, such as terpene, terpene-phenolic, C₅, C₉ and C₅/C₉ hydrocarbon, pinene and indene resins or rosins, alone or in combination with one another, can be added. It is also possible, furthermore, to use plasticizers, various fillers (for example fibers, carbon black, zinc oxide, titanium dioxide, solid microbeads, solid or hollow glass beads, silica, silicates, chalk, blocking-free isocyanates, etc.), aging inhibitors, light stabilizers, ozone protectants, fatty acids, nucleating agents, expandants and/or accelerants as additives. Crosslinkers and crosslinking promoters can also be mixed in. Examples of suitable crosslinkers for electron beam crosslinking are difunctional or polyfunctional acrylates, difunctional or polyfunctional isocyanates or difunctional or polyfunctional epoxides.

The acrylate hotmelts, as they are or in the form of blends, are coated onto the backing material through a die with a variable slot width and then are cured on the backing using electron beams. In inline operation, crosslinking takes place immediately after the pressure-sensitive adhesive has been applied to the backing.

The combination of the apparatus and the backing material web affords a multiplicity of advantages which as such could not have been foreseen. The dispensing of the adhesive tape sections is not accompanied by any loss of time owing to the removal of a liner, and involves less waste. Different sizes of the adhesive tape sections—adhered in different numbers—make it possible, so to speak, to “dose” the required amount of adhesive tape.

The apparatus preferably uses double-sided self-adhesive tape sections which are disposed gaplessly on the backing material web: for example, a double-sided self-adhesive tape 15 mm wide with a transverse separation every 15 mm. In other words, a stretch of adhesive of, for example, 90 mm is replaced by 6 15 mm adhesive tape sections. Other, arbitrary dimensions are likewise conceivable. By virtue of the adhesive tape sections 15 mm in length it is possible for even an inherently rigid double-sided self-adhesive tape with carrier to be bonded in curves with the assistance of the apparatus of the invention.

The apparatus features adjustable start and end marking, enabling the user to position any desired number of adhesive tape sections on the substrate. All functional elements are arranged in such a way that the dispensing operation can be accomplished not just in the normal, traction mode, but also, preferably, by means of a pushing movement.

To summarize, the method of the invention offers the following advantages:

The method is used for fixing cable harnesses to surfaces, especially surfaces of passenger cars, in such a way that the cable system can be applied to the passenger car component in a single workstep with high positional precision.

For this purpose, a special gun, which can also be mounted on a robot, applies a tape, equipped with double-sided adhesive tape sections, directly to the substrate, the roof lining for example, and the gun automatically rolls up the tape. The adhesive tape allows adhesive pieces lying in close succession to be positioned on a roll in such a way that, on unrolling by way of a specific applicator, these pieces automatically cross to/remain adhering on the surface (substrate) of the passenger car component. For that purpose, the release paper is provided in a special layer whose repellency differs on either side, allowing a continuous, rapid application/transfer of the sections. The gun (apparatus) allows flexible application: that is, it can be placed at the site of intended application and easily lifted off at the point where application is to end. The method operates without cutters or blades, so that there is no possibility of injury to the operative during the job. This method is also advantageous since there is no need during application for any cutters or a blade, which might damage the cable harness during cutting or, by introducing a notch, might make it unusable.

The combination of the textile tape, made self-adhesive where appropriate, with the adhesive diecuts ensures durable fixing of the cable harness, since
the fibrous surface exhibits very good, spontaneous adhesion to the thick cushion of adhesive
the loose sheathing of the cable strand results spontaneously, in the course of assembly, in a bond area which is extensive rather than pointwise
the loose sheathing ensures better distribution of force into the bondline under load.

Additional advantages below result in comparison to pastelike adhesives such as hotmelt adhesives:
no observance of defined open times prior to assembly
no reacting times of the pastelike adhesive after assembly
clean, quick handling
no loss in time from topping up the stock vessel with powder granules to keep the hot adhesive fluid (hotmelts)
no risk to coworkers from skin burns
no maintenance
no laborious manual moving of a heavy swivel crane over the assembly bench (heavy hotmelt gun is fastened to a crane which has to be moved manually)
no energy consumption (though in the case of hotmelt)
no mandatory apparatus expenditure
adhesive application can be automated
productivity increase in manufacturing operation of cable assembly on passenger-car interior component.

### BRIEF DESCRIPTION OF THE DRAWINGS

Particularly advantageous embodiments of the apparatus are illustrated with reference to the below-described figures, without wishing thereby to restrict the invention unnecessarily. Specifically

FIG. 1 shows the apparatus with a roll of the backing material web, in one especially advantageous embodiment, and

FIG. 2 shows a roll of the backing material web with adhesive tape sections.

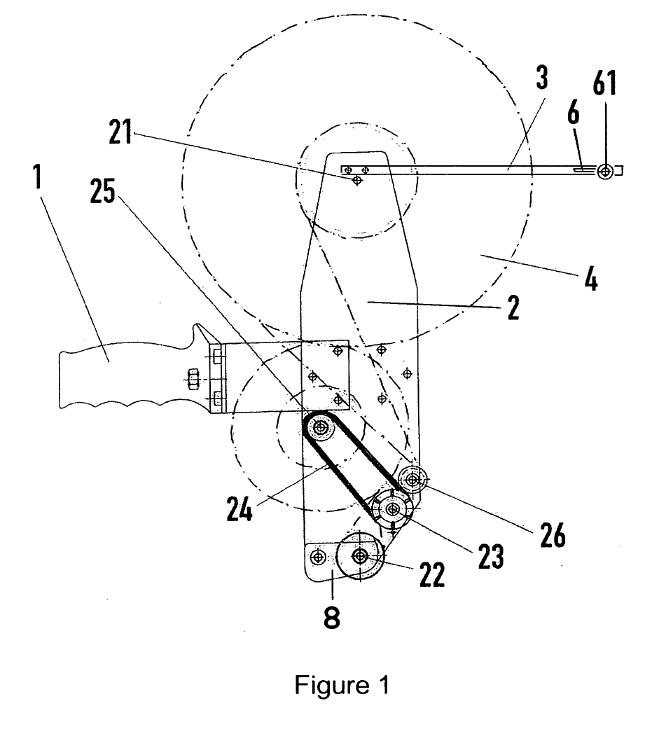

FIG. 1 shows the apparatus for unrolling a backing material web 41, present on a roll 4, with double-sided adhesive tape sections 42. The apparatus is composed of a number of individual components. The central component is the baseplate 2, which serves to accommodate all other components, such as a handle 1 which is screwed to the baseplate 2. Simply changing the position of the handle 1 allows the apparatus to be moved in traction and, in particular, in a pushing movement during the dispensing operation. Preferably the apparatus is pushed, since ergonomically speaking a greater pressing force, which is advantageous for pressure-sensitive self-adhesive compositions, is much easier to apply in the case of a pushing movement.

A rotatably mounted receiver 21 for the roll 4 of backing material web 41 is then provided on the baseplate 2.

Also present in rotatable mounting on the baseplate 2 is a pressure roller 22 which during the dispensing operation brings the backing material web 41 with the adhesive tape sections 42 into contact with the substrate and which, via 21 for the roll 4, is guided in such a way that the adhesive tape sections 42 are dispensed onto the substrate from the backing material web 41 during the dispensing operation. The material and diameter of the pressure roller 22 are such that, on the one hand, a sufficient applied pressure is ensured for the bonding of the self-adhesive tape sections 42 and, on the other hand, the backing material web 41 can be removed readily from the double-sided adhesive tape sections 42 in the course of dispensing. In this case the roller 22 is attuned specifically to the properties of the double-sided adhesive tape sections 42 on the backing material web 41.

By way of a drive roller 23 mounted rotatably on the baseplate 2 the backing material web 41 with the adhesive tape sections 42 is guided in such a way that the drive roller 23 rotates synchronously with respect to the speed of the backing material web 41.

The drive roller 23 is disposed between the receiver 21 for the roll 4 of backing material web 41 and the pressure roller 22.

So that the backing material web 41 exhibits a large angle of wrap around the drive roller, a guide roller 26 is disposed between the receiver 21 for the roll 4 of backing material web 41 and the drive roller 23, and in turn is surrounded by the backing material web 41.

Located on the baseplate 2, finally, is a rotatably mounted receiving roller 25, which receives the backing material web 41 after the adhesive tape sections 42 have been dispensed and which in particular is set in rotation via a belt 24 by the movement of the drive roller 23.

Provided on the holding means 2, on a fixable axle 3, is an adjustable positioning aid 6, in the form of a rotatably mounted shaft 61 which can be fixed by screwing and via which the backing material web 41 is guided from the receiver 21 for the roll 4 of the backing material web 41 in the direction of drive roller 23.

One side of the pressure roller 22 is fixed on the baseplate 2, and the other side carries a counterplate 8. In the case of the apparatus 100 which is pushed during the dispensing operation the counterplate 8 and the baseplate 2 are of prolonged design in the direction of the handle 1. In terms of their shape, the counterplate 8 and the baseplate 2 are harmonized with the pressure roller 22 and the lever arm of the handle 1 in such a way that at the end of the dispensing operation the entire apparatus can easily be tipped by the user about the fulcrum which results from this geometry. As a result of this turning movement it is always possible, in conjunction with the positioning aid 6, on the one hand to dispense the last adhesive tape section 42 reliably, i.e., to transfer it from the backing material web 41 to the substrate, while on the other hand the next adhesive tape section 42, not to be applied until later, is still held securely on the backing material web 41.

The whole apparatus is harmonized in such a way that with either an empty or a full receiving roller 25 there is no adverse effect on the positioning accuracy of the double-sided self-adhesive tape sections 42. This relates in particular to the transmission ratio of the belt drive between the rollers 23 and 25.

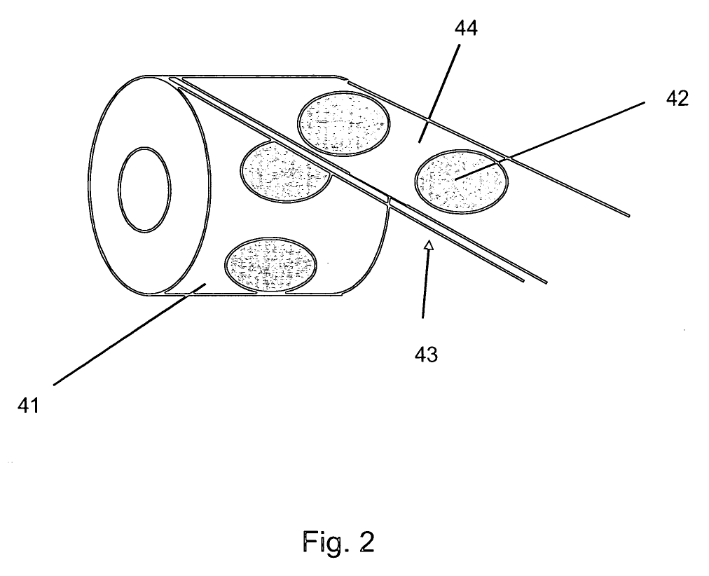

In accordance with FIG. 2, the backing material web 41 is wound into a roll in the form of an Archimedean spiral. On the backing material web 41 the individual adhesive tape sections 42, here in the form of circles, are arranged at regular intervals. The backing material web 41 has different antiadhesive coatings 43, 44. The antiadhesive coating 43 located on the bottom face of the backing material web 41 has a higher degree of repellency than the antiadhesive coating 44 located on the top face of the backing material web 41.

What is claimed is:

1. A method of bonding a cable harness adhesively to a substrate, which comprises a) enveloping individual cables with a textile tape provided optionally on one side with a self-adhesive coating, thus forming a cable harness, and b) fixing the cable harness to the substrate by means of one or more double-sided adhesive tape sections.

2. The method of claim 1, which is performed on an apparatus comprising
a) a baseplate;
b) a handle fitted to the baseplate;
c) a receiver mounted rotatably on the baseplate and intended for a roll of backing material web;
d) a pressure roller which is mounted rotatably on the baseplate and which during a dispensing operation brings the backing material web with the one or more double-sided adhesive tape sections into contact with the substrate and is guided in such a way that the one or more double-sided adhesive tape sections are dispensed onto the substrate from the backing material web during the dispensing operation;
e) a drive roller which is mounted rotatably on the baseplate and via which the backing material web with the one or more adhesive tape sections is guided in such a way that the drive roller rotates synchronously with respect to a speed obtained by the backing material web;
f) a receiver roller which is mounted rotatably on the baseplate and which receives the backing material web after the one or more double-sided adhesive tape sections have been dispensed, and which optionally is set in rotation via a belt by a movement of the drive roller.

3. The method of claim 2, wherein
the drive roller is disposed between the receiver for the roll of backing material web and the pressure roller and/or
a guide roller is disposed between the receiver for the roll of backing material web and the drive roller.

4. The method of claim 2, wherein
an axle is fixed on the handle and comprises an adjustable positioning aid in the form of a rotatably mounted shaft which can be fixed by screwing, via which the backing material web is guided from the receiver for the roll of backing material web in the direction of the drive roller.

5. The method of claim 2, wherein
one side of the pressure roller is fixed on the baseplate and another side carries a counterplate, the counterplate and the baseplate being of prolonged design in the direction of the handle in the case of an apparatus which is pushed during the dispensing operation.

6. The method of claim 2, wherein
the apparatus is guided by a robot, so that the one or more double-sided adhesive tape sections are applied to the cable harness at precisely predetermined locations.

7. The method of claim 1, wherein
the textile tape is guided in a spiral movement around the individual cables, there having been applied optionally at least to one side of the tape an adhesive in a longitudinal direction in the form of a stripe which is narrower than the tape.

8. The method of claim 1, wherein
the textile tape comprises consolidated nonwoven webs consolidated optionally by overstitching with separate threads or by interlooping or water jets or needles.
